(19) United States
(12) Patent Application Publication
(10) Pub. No.: US 2026/0093698 A1
(43) Pub. Date: Apr. 2, 2026

(54) METHOD AND APPARATUS FOR HOTSPOT DATA DETECTION FOR DATABASE, AND STORAGE MEDIUM

(71) Applicant: Beijing Volcano Engine Technology Co., Ltd., Haidian District (CN)

(72) Inventors: Wei Huang, Beijing (CN); Zaiyu Pan, Beijing (CN)

(21) Appl. No.: 19/267,870

(22) Filed: Jul. 14, 2025

(30) Foreign Application Priority Data
Sep. 27, 2024 (CN) 202411367703.8

(51) Int. Cl. G06F 16/2453

(52) U.S. Cl. CPC G06F 16/24539

(57) ABSTRACT

According to the embodiments of the present disclosure, a method and apparatus for hotspot data detection for a database and a storage medium are provided. The method includes: receiving a database query instruction, and determining whether a target primary key of data to be queried exists in a real-time hotspot primary key set corresponding to a current time period; if the target primary key does not exist, controlling, through a target cache, whether to add the target primary key to the real-time hotspot primary key set, the target cache is a cache; if the target primary key exists, accumulating, a query frequency of the target primary key in the current time period; and determining, after the current time period ends, a hotspot primary key of the current time period based on the real-time hotspot primary key set, and outputting a query frequency of the hotspot primary key.

### CROSS-REFERENCE TO RELATED APPLICATION(S)

This application claims priority to Chinese Application No. 202411367703.8 filed on Sep. 27, 2024, the disclosure of which is incorporated herein by reference in its entirety.

### FIELD

Embodiments of the present disclosure relate to the field of computer and network communication technologies, and in particular, to a method and apparatus for hotspot data detection for a database, and a storage medium.

### BACKGROUND

In some real-time applications of a database, it is usually necessary to count a query per second (QPS) of a hotspot primary key being queried, so as to optimize a system load.

However, in the prior art, it is usually impossible to provide accurate QPS count for a primary key being queried in the database, and at the same time, for some primary keys being queried, if they do not exist in the database or are deleted after being written, they cannot be counted either, so it is impossible to count the hotspot primary key and its QPS in the database in real time and accurately.

### SUMMARY

Embodiments of the present disclosure provide a method and apparatus for hotspot data detection for a database, and a storage medium.

In a first aspect, an embodiment of the present disclosure provides a method for hotspot data detection for a database, including:
receiving a database query instruction, and determining whether a target primary key of data to be queried exists in a real-time hotspot primary key set corresponding to a current time period;
if the target primary key does not exist in the real-time hotspot primary key set, controlling, through a target cache, whether to add the target primary key to the real-time hotspot primary key set, where the target cache is a cache based on a least recently used algorithm;
if the target primary key exists in the real-time hotspot primary key set, accumulating, in the real-time hotspot primary key set, a query frequency of the target primary key in the current time period; and
determining, after the current time period ends, a hotspot primary key of the current time period based on the real-time hotspot primary key set, and outputting a query frequency of the hotspot primary key of the current time period in the current time period.

In a second aspect, an embodiment of the present disclosure provides an apparatus for hotspot data detection for a database, including:
a determining unit configured to receive a database query instruction, and determine whether a target primary key of data to be queried exists in a real-time hotspot primary key set corresponding to a current time period;
a caching unit configured to, if the target primary key does not exist in the real-time hotspot primary key set, control, through a target cache, whether to add the target primary key to the real-time hotspot primary key set, where the target cache is a cache based on a least recently used algorithm;
a recording unit configured to, if the target primary key exists in the real-time hotspot primary key set, accumulate, in the real-time hotspot primary key set, a query frequency of the target primary key in the current time period; and
a counting unit configured to determine, after the current time period ends, a hotspot primary key of the current time period based on the real-time hotspot primary key set, and output a query frequency of the hotspot primary key of the current time period in the current time period.

In a third aspect, an embodiment of the present disclosure provides an electronic device, including: at least one processor and a memory;
where the memory stores computer-executable instructions; and
the at least one processor executes the computer-executable instructions stored in the memory, to cause the at least one processor to perform the method for hotspot data detection for a database according to the above first aspect and various possible designs of the first aspect.

In a fourth aspect, an embodiment of the present disclosure provides a computer-readable storage medium. The computer-readable storage medium stores computer-executable instructions which, when executed by a processor, implement the method for hotspot data detection for a database according to the above first aspect and various possible designs of the first aspect.

In a fifth aspect, an embodiment of the present disclosure provides a computer program product, including computer-executable instructions which, when executed by a processor, implement the method for hotspot data detection for a database according to the above first aspect and various possible designs of the first aspect.

### BRIEF DESCRIPTION OF THE DRAWINGS

In order to illustrate the technical solutions in the embodiments of the present disclosure or in the prior art more clearly, the following will briefly introduce the drawings needed in describing the embodiments or the prior art. Obviously, the drawings in the following description are some embodiments of the present disclosure, and for those of ordinary skill in the art, other drawings can be obtained according to these drawings without creative effort.

FIG. 1 is a schematic diagram of a scenario of a method for hotspot data detection for a database according to an embodiment of the present disclosure;

FIG. 2 is a schematic flowchart of a method for hotspot data detection for a database according to an embodiment of the present disclosure;

FIG. 3 is a schematic diagram of a preset queue according to an embodiment of the present disclosure;

FIG. 4 is a schematic flowchart of a method for hotspot data detection for a database according to another embodiment of the present disclosure;

FIG. 5 is a block diagram of a structure of an apparatus for hotspot data detection for a database according to an embodiment of the present disclosure; and

FIG. 6 is a schematic diagram of a hardware structure of an electronic device according to an embodiment of the present disclosure.

### DETAILED DESCRIPTION OF EMBODIMENTS

In order to make the objectives, technical solutions and advantages of the embodiments of the present disclosure clearer, the technical solutions in the embodiments of the present disclosure will be described clearly and completely below with reference to the drawings in the embodiments of the present disclosure. Obviously, the described embodiments are part of the embodiments of the present disclosure, but not all of them. Based on the embodiments in the present disclosure, all other embodiments obtained by those of ordinary skill in the art without creative effort shall fall within the protection scope of the present disclosure.

In some real-time applications of a database, it is usually necessary to count a query per second (QPS) of a hotspot primary key being queried, so as to optimize a system load, for example, a Redis database. Redis is an open-source in-memory database, which is widely used in scenarios such as a cache, a message queue, a real-time analysis, etc. Using Redis can help users improve system performance, reduce database load, and support a variety of data structures, such as strings, lists, sets, etc., to meet the needs of different users. In real-time applications of the Redis database, it is also necessary to count the QPS of the hotspot primary key being queried.

However, in the prior art, it is usually impossible to provide accurate QPS count for a primary key being queried in the database, and at the same time, for some primary keys being queried, if they do not exist in the database or are deleted after being written, they cannot be counted either, so it is impossible to count the hotspot primary key and its QPS in the database in real time and accurately.

Some cloud vendors provide counts for hotspot primary keys and their QPS, but it is usually counted based on value-object, and only QPS range values can be given. Usually, the query times of each primary key are accumulated, and the ratio of the query times to time is calculated as the QPS value, which will lead to the QPS of the hotspot primary key being not real-time, and not a real reflection of the query times of the primary key per second. At the same time, the ratio based on the time period will lead to an overly long attenuation period of the QPS of the hotspot primary key. In addition, it is also impossible to count the primary key being queried that does not exist in the database.

In order to solve the above technical problems, an embodiment of the present disclosure provides a method for hotspot data detection for a database. The method does not count based on value-object, but directly counts the primary key of the data to be queried in the database query instruction, so whether the primary key actually exists in the database or not will not affect the counting of the primary key. In addition, with the aid of the cache based on the least recently used algorithm and the time-sharing counting, the low-frequency primary key can be effectively filtered, the data volume can be reduced, so that the system load can be reduced, and the hotspot primary key and its query frequency in the current time period can be determined from the primary keys being queried in real time and accurately, thereby improving the real-time performance and accuracy, and avoiding the problem of an overly long attenuation period of the QPS of the hotspot primary key.

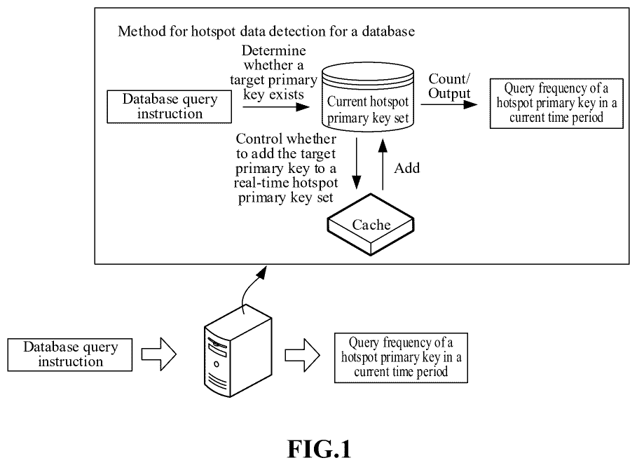

As shown in FIG. 1, it shows an application scenario of the method for hotspot data detection for a database according to an embodiment of the present disclosure, which can be applied to electronic devices such as a database server. Specifically, a database query instruction is received, and whether a target primary key of data to be queried exists in a real-time hotspot primary key set corresponding to a current time period is determined. If the target primary key does not exist in the real-time hotspot primary key set, whether to add the target primary key to the real-time hotspot primary key set is controlled through a target cache, where the target cache is a cache based on a least recently used algorithm. Alternatively, if the target primary key exists in the real-time hotspot primary key set, a query frequency of the target primary key in the current time period is accumulated in the real-time hotspot primary key set. After the current time period ends, a hotspot primary key of the current time period is determined based on the real-time hotspot primary key set, and a query frequency of the hotspot primary key of the current time period in the current time period is output.

The method for hotspot data detection for a database of the present disclosure will be described in detail below with reference to specific embodiments.

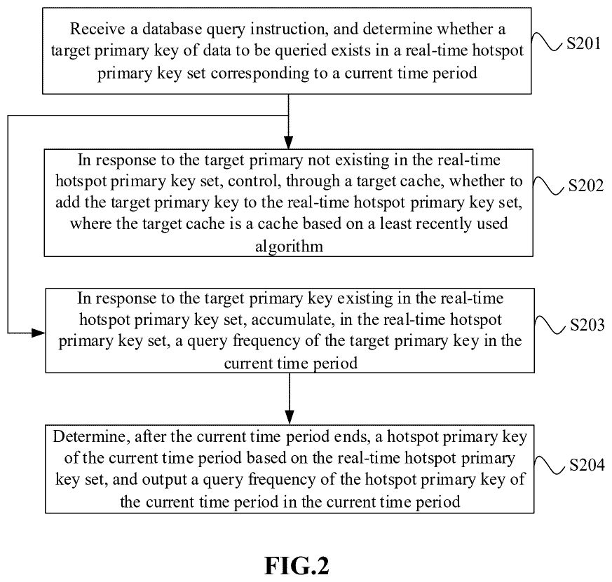

Reference is made to FIG. 2, which is a schematic flowchart of a method for hotspot data detection for a database according to an embodiment of the present disclosure. The method of this embodiment can be applied to a terminal device or a server. The method for hotspot data detection for a database includes the following steps.

At S201, a database query instruction is received, and whether a target primary key of data to be queried exists in a real-time hotspot primary key set corresponding to a current time period is determined.

In this embodiment, when the database query instruction is received, the target primary key of the data to be queried can be determined from the database query instruction. The database query instruction may include the target primary key of the data to be queried.

A real-time hotspot primary key set can be configured for each time period. The real-time hotspot primary key set can be used to store candidate hotspot primary keys in a corresponding time period, and the candidate hotspot primary keys are primary keys that are frequently queried, and need to meet certain conditions to be added to the real-time hotspot primary key set, which will be described in detail in the following steps.

In addition, the time period can be set according to actual requirements, for example, the time period can be 1 second, that is, each second corresponds to a real-time hotspot primary key set, so that hotspot primary key count at a second level can be achieved. Certainly, the time period is not limited to 1 second, and can also be another preset duration.

In this embodiment, after the database query instruction is received, real-time determination can be performed based on the real-time hotspot primary key set corresponding to the current time period, to determine whether the target primary key of the data to be queried exists in the real-time hotspot primary key set corresponding to the current time period, that is, to determine whether the target primary key of the data to be queried has been determined as a candidate hotspot primary key in the current time period.

Further, different operations can be performed based on the determination result. Specifically, if it is determined that the target primary key does not exist in the real-time hotspot primary key set, S202 is performed. If it is determined that the target primary key exists in the real-time hotspot primary key set, S203 is performed.

At S202, if the target primary key does not exist in the real-time hotspot primary key set, it is controlled, through a target cache, whether to add the target primary key to the real-time hotspot primary key set. The target cache is a cache based on a least recently used algorithm.

In this embodiment, a target cache based on a least recently used algorithm (LRU), that is, an LRU cache, is configured in advance, which can be used to filter out some primary keys with a low query frequency. The least recently used algorithm is to eliminate the least recently used cache data to release more cache space when the cache space is full.

In this embodiment, the primary keys that can be stored in the target cache based on the least recently used algorithm are primary keys that do not exist in the real-time hotspot primary key set and have been recently queried. The primary keys that are not frequently queried recently can be filtered out based on the least recently used algorithm, and then the primary keys that do not exist in the real-time hotspot primary key set and have been frequently queried recently can be added to the real-time hotspot primary key set.

Optionally, S202 may specifically include the following steps.

At S2021, whether the target primary key is stored in the target cache is determined.

If the target primary key is not stored in the target cache, S2022 is performed; and if the target primary key is stored in the target cache, S2023 is performed.

At S2022, if the target primary key is not stored in the target cache, the target primary key is added to the target cache based on the least recently used algorithm.

At S2023, if the target primary key is stored in the target cache, the target primary key is removed from the target cache, and the target primary key is added to the real-time hotspot primary key set.

In this embodiment, since a storage space of the target cache based on the least recently used algorithm is limited, that is, the number of primary keys that can be cached is limited, for a target primary key that does not exist in the real-time hotspot primary key set, if the target primary key is not stored in the target cache, it means that there may be two cases. One case is that the target primary key has never been queried before, and this is the first time it has been queried. The other case is that the target primary key has been queried before, and has been stored in the target cache, but the query frequency is not high, and it is eliminated based on the least recently used algorithm and cleared from the target cache. In any case, as long as the target primary key is not stored in the target cache, the target primary key is added to the target cache based on the least recently used algorithm. It should be noted that in this embodiment, the number of times the target primary key is queried may not be recorded in the target cache based on the least recently used algorithm. Adding the target primary key to the target cache based on the least recently used algorithm specifically includes: if there is a storage location in the target cache, directly storing the target primary key in the target cache, and if there is no storage location in the target cache, eliminating the earliest queried primary key stored in the target cache without paying attention to the number of times it is queried. As long as the target primary key is already stored in the target cache, it means that the time interval between this query of the target primary key and the last query of the target primary key may be relatively close, or there are few queries for other primary keys between this query of the target primary key and the last query of the target primary key, and the target primary key already stored in the target cache has not been eliminated by other primary keys, which further indicates that the target primary key is queried at a relatively high frequency. The target primary key can be added to the real-time hotspot primary key set, and the target primary key is removed from the target cache. Subsequently, the query condition of the target primary key only needs to be focused on through the real-time hotspot primary key set, without occupying the storage space of the target cache.

Optionally, the size of the storage space of the target cache based on the least recently used algorithm can determine the size of the query frequency of the primary keys that can be added to the real-time hotspot primary key set. Therefore, the size of the storage space of the target cache, that is, the number of primary keys allowed to be stored in the target cache, can be determined based on the total number of queries allowed by the database in a single time period and a query frequency threshold for a preset single time period, and then the storage space of the target cache is configured based on the number of primary keys allowed to be stored.

For example, if the total number of queries allowed by the database in a single time period is 100,000 times, and the query frequency threshold for the preset single time period is 3000 times, that is, if a primary key is queried 3000 times per second, it is considered as a hotspot primary key. If a certain primary key is a hotspot primary key, it will be queried once every 100,000/3000≈33 queries on average. Therefore, the number of primary keys allowed to be stored in the target cache can be set to 32. If a target primary key has been stored in the target cache, and if the target primary key is not a hotspot primary key, it is very likely that it will not be queried again in the subsequent 32 queries, and it will be eliminated from the target cache based on the least recently used algorithm. If the target primary key is a hotspot primary key, it is very likely that it will be queried again in the subsequent 32 queries, and when the target primary key is queried again, the target primary key already stored in the target cache has not been eliminated, so it can be added to the real-time hotspot primary key set. By setting the number of primary keys allowed to be stored in the target cache based on the ratio of the total number of queries allowed by the database in a single time period to the query frequency threshold for the preset single time period, the hotspot primary key can be preliminarily filtered, and the primary key with a low query frequency can be filtered out.

At S203, if the target primary key exists in the real-time hotspot primary key set, it is accumulated, in the real-time hotspot primary key set, a query frequency of the target primary key in the current time period.

In this embodiment, if the target primary key exists in the real-time hotspot primary key set, the query frequency of the target primary key in the current time period may be directly accumulated in the real-time hotspot primary key set. Specifically, when the target primary key is added to the real-time hotspot primary key set for the first time, the query frequency of the target primary key in the current time period is recorded as 1. If the target primary key is queried again in the current time period, the query frequency of the target primary key in the current time period is accumulated by 1 each time the target primary key is queried. Finally, the query frequency of the target primary key in the current time period can be obtained at the end of the current time period. If the length of the time period is 1 second, the query frequency of the target primary key in the current time period is the QPS of the target primary key in the current 1 second.

At S204, after the current time period ends, a hotspot primary key of the current time period is determined based on the real-time hotspot primary key set, and a query frequency of the hotspot primary key of the current time period in the current time period is output.

In this embodiment, after the current time period ends, the real-time hotspot primary key set records the query frequencies of all candidate hotspot primary keys in the current time period, and then the hotspot primary key in the current time period can be determined based on the real-time hotspot primary key set.

Optionally, the query frequencies of all candidate hotspot primary keys in the real-time hotspot primary key set in the current time period may be sorted, and the first preset number of primary keys with the highest query frequencies in the current time period are determined as the hotspot primary keys in the current time period. For example, if the first preset number is k, the Top k primary keys with the highest query frequencies in the current time period in the real-time hotspot primary key set are determined as the hotspot primary keys in the current time period.

Further, since the real-time hotspot primary key set may include a relatively large number of primary keys, in order to improve the sorting efficiency, a filtering can be performed first to filter out the primary keys with a low query frequency in the current time period. Specifically, the primary keys of which the query frequencies in the current time period are lower than the query frequency threshold for the preset single time period in the real-time hotspot primary key set can be filtered out, and then the remaining primary keys in the real-time hotspot primary key set are sorted based on the query frequencies in the current time period, so that the amount of data to be sorted can be reduced, and the sorting efficiency can be improved, thereby quickly determining the hotspot primary key in the current time period.

Optionally, the process of S204 has a relatively low requirement for real-time performance compared with the preceding steps. The real-time hotspot primary key set corresponding to the current time period can be output, and the real-time hotspot primary key set corresponding to the current time period is processed in an asynchronous manner, to determine the hotspot primary key in the current time period, and output the query frequency of the hotspot primary key of the current time period in the current time period, so that the impact on the performance of a main thread can be reduced.

According to the method for hotspot data detection for a database provided by this embodiment, a database query instruction is received, and whether a target primary key of data to be queried exists in a real-time hotspot primary key set corresponding to a current time period is determined. If the target primary key does not exist in the real-time hotspot primary key set, whether to add the target primary key to the real-time hotspot primary key set is controlled through a target cache, where the target cache is a cache based on a least recently used algorithm. Alternatively, if the target primary key exists in the real-time hotspot primary key set, a query frequency of the target primary key in the current time period is accumulated in the real-time hotspot primary key set. After the current time period ends, a hotspot primary key of the current time period is determined based on the real-time hotspot primary key set, and a query frequency of the hotspot primary key of the current time period in the current time period is output. By means of the cache based on the least recently used algorithm, a low-frequency primary key can be effectively filtered, the data volume can be reduced, so that the system load can be reduced, and the hotspot primary key and its query frequency in the current time period can be determined from the primary keys being queried in real time and accurately, thereby solving the problem that it is impossible to count the primary key being queried that does not exist in the database.

On the basis of any of the above embodiments, one time period may correspond to multiple real-time hotspot primary key sets, and the number of primary keys that can be stored in each real-time hotspot primary key set does not exceed a preset primary key number threshold. Parallel processing can be achieved by dividing multiple real-time hotspot primary key sets. In particular, when determining whether the target primary key exists in the real-time hotspot primary key set corresponding to the current time period, it is possible to query in parallel whether the target primary key exists from multiple real-time hotspot primary key sets corresponding to the current time period, which can improve the query efficiency. In addition, after the current time period ends, the multiple real-time hotspot primary key sets corresponding to the current time period may also be sorted in parallel, and finally the sorting is summarized, which can improve the sorting efficiency, thereby quickly determining the hotspot primary key in the current time period.

On the basis of the above embodiment, in S202 and S2023, when the target primary key is added to the real-time hotspot primary key set, the method specifically includes the following steps:
determining whether the number of primary keys included in a first real-time hotspot primary key set corresponding to the current time period reaches a preset primary key number threshold;
if the preset primary key number threshold is not reached, adding the target primary key to the first real-time hotspot primary key set; or
if the preset primary key number threshold is reached, creating a second real-time hotspot primary key set corresponding to the current time period, and adding the target primary key to the second real-time hotspot primary key set.

In this embodiment, since the number of primary keys that can be stored in each real-time hotspot primary key set does not exceed the preset primary key number threshold, when the target primary key is added to the first real-time hotspot primary key set corresponding to the current time period, it is possible to determine whether the number of primary keys included in the first real-time hotspot primary key set reaches the preset primary key number threshold. If the number of primary keys included in the first real-time hotspot primary key set does not reach the preset primary key number threshold, it means that the first real-time hotspot primary key set is not full and can continue to store the target primary key, and then the target primary key can be added to the first real-time hotspot primary key set. If the number of primary keys included in the first real-time hotspot primary key set has reached the preset primary key number threshold, it means that the first real-time hotspot primary key set is full and cannot continue to store the target primary key, then it is necessary to create the second real-time hotspot primary key set corresponding to the current time period, and add the target primary key to the second real-time hotspot primary key set.

On the basis of the above embodiment, in S204, after the current time period ends, when the hotspot primary key of the current time period is determined based on the real-time hotspot primary key set, the method specifically includes the following step:
merging, after the current time period ends, all real-time hotspot primary key sets in the current time period, and determining the hotspot primary key in the current time period based on the merged real-time hotspot primary key set.

In this embodiment, since one time period may correspond to multiple real-time hotspot primary key sets, all the real-time hotspot primary key sets corresponding to the current time period can be merged when determining the hotspot primary key in the current time period, so that a union set can be obtained, and then the merged real-time hotspot primary key set is sorted based on the query frequencies of the primary keys in the current time period, to determine the hotspot primary key in the current time period.

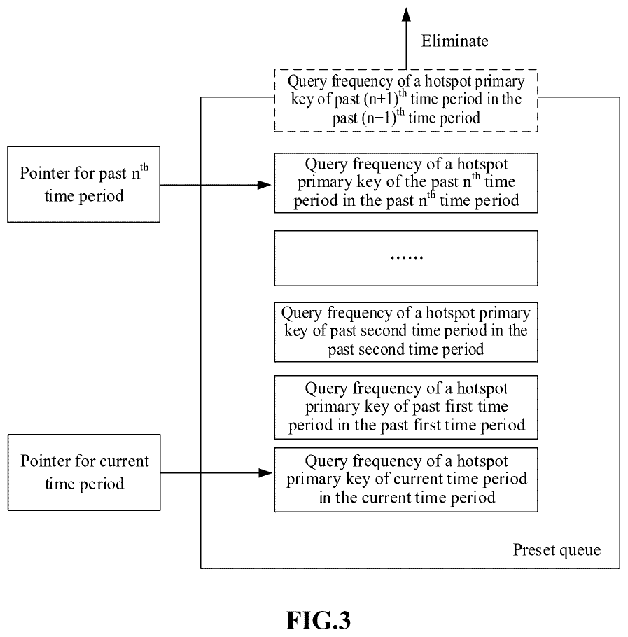

The real-time hotspot primary key set, on the basis of any of the above embodiments, when outputting the query frequency of the hotspot primary key of the current time period in the current time period, may sore the query frequency of the hotspot primary key in the current time period in a preset queue, as shown in FIG. 3. The preset queue can be used to store query frequencies of hotspot primary keys of the second preset number of past time periods in corresponding time periods. For example, it can store query frequencies of hotspot primary keys in the past n time periods in corresponding time periods, and continuously eliminate the query frequency of the hotspot primary key in the earliest time period in the corresponding time period.

Therefore, in this embodiment, when storing the query frequency of the hotspot primary key of the current time period in the current time period in the preset queue, it is first determined whether the preset queue is full. If the preset queue is not full, the query frequency of the hotspot primary key of the current time period in the current time period is stored in the preset queue; and if the preset queue is full, the query frequency of the hotspot primary key of the earliest time period in the corresponding time period in the preset queue is deleted, and the query frequency of the hotspot primary key in the current time period is stored in the preset queue.

In another optional embodiment, when the query frequency of the hotspot primary key of any target time period in the corresponding time period in the preset queue is read, it can also be deleted. That is, in response to a read request for the query frequency of the hotspot primary key of any target time period in the corresponding time period in the preset queue, the query frequency of the hotspot primary key of the target time period in the corresponding time period is output, and the query frequency of the hotspot primary key of the target time period in the corresponding time period is deleted from the preset queue.

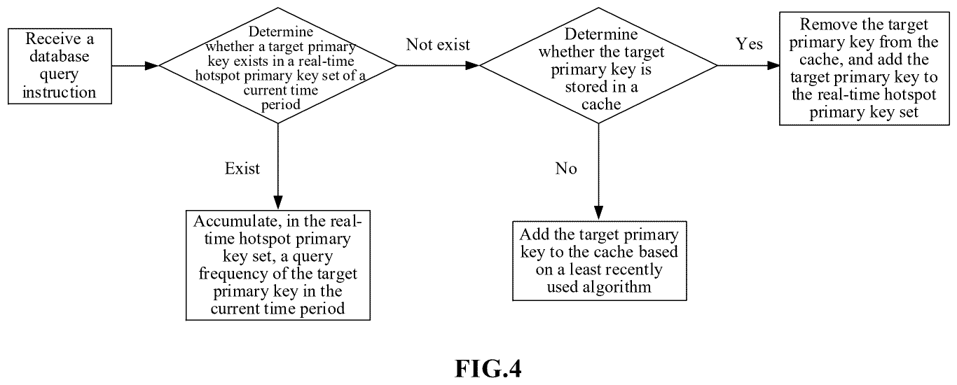

On the basis of any of the above embodiments, as shown in FIG. 4, this embodiment provides a method for hotspot data detection for a database, which specifically includes the following steps.

At S401, a database query instruction is received

At S402, whether a target primary key of data to be queried exists in a real-time hotspot primary key set corresponding to a current time period is determined.

If it is determined that the target primary key does not exist in the real-time hotspot primary key set, S403 is performed, and if it is determined that the target primary key exists in the real-time hotspot primary key set, S403 is performed.

At S403, whether the target primary key is stored in the target cache is determined.

The target cache is a cache based on a least recently used algorithm. If the target primary key is not stored in the target cache, S404 is performed; and if the target primary key is stored in the target cache, S405 is performed;

At S404, the target primary key is added to the target cache based on the least recently used algorithm.

At S405, the target primary key is removed from the target cache, and the target primary key is added to the real-time hotspot primary key set.

At S406, in the real-time hotspot primary key set, the query frequency of the target primary key in the current time period is accumulated.

Further, after the current time period ends, a hotspot primary key of the current time period is determined based on the real-time hotspot primary key set, and a query frequency of the hotspot primary key of the current time period in the current time period is output (not shown in FIG. 4).

Corresponding to the method for hotspot data detection for a database in the preceding embodiments, FIG. 5 is a block diagram of a structure of an apparatus for hotspot data detection for a database according to an embodiment of the present disclosure. For ease of description, only parts related to the embodiments of the present disclosure are shown. Referring to FIG. 5, the apparatus 500 for hotspot data detection for a database includes: a determining unit 501, a caching unit 502, and a recording unit 503.

The determining unit 501 is configured to receive a database query instruction, and determine whether a target primary key of data to be queried exists in a real-time hotspot primary key set corresponding to a current time period.

The caching unit 502 is configured to, if the target primary key does not exist in the real-time hotspot primary key set, control, through a target cache, whether to add the target primary key to the real-time hotspot primary key set. The target cache is a cache based on a least recently used algorithm.

The recording unit 503 is configured to, if the target primary key exists in the real-time hotspot primary key set, accumulate, in the real-time hotspot primary key set, a query frequency of the target primary key in the current time period.

The counting unit is configured to determine, after the current time period ends, a hotspot primary key of the current time period based on the real-time hotspot primary key set, and output a query frequency of the hotspot primary key of the current time period in the current time period.

In one or more embodiments of the present disclosure, the caching unit 502, when controlling, through the target cache, whether to add the target primary key to the real-time hotspot primary key set, is configured to:

determine whether the target primary key is stored in the target cache; and
if the target primary key is not stored in the target cache, add the target primary key to the target cache based on the least recently used algorithm; or
if the target primary key is stored in the target cache, remove the target primary key from the target cache, and add the target primary key to the real-time hotspot primary key set.

In one or more embodiments of the present disclosure, the caching unit 502 is further configured to:
determine the number of primary keys allowed to be stored in the target cache based on the total number of queries allowed by the database in a single time period and a query frequency threshold for the preset single time period, and configure the storage space of the target cache based on the number of primary keys allowed to be stored.

In one or more embodiments of the present disclosure, the recording unit 503, when adding the target primary key to the real-time hotspot primary key set, is configured to:
determine whether the number of primary keys included in a first real-time hotspot primary key set corresponding to the current time period reaches a preset primary key number threshold;
if the preset primary key number threshold is not reached, add the target primary key to the first real-time hotspot primary key set; or
if the preset primary key number threshold is reached, create a second real-time hotspot primary key set corresponding to the current time period, and add the target primary key to the second real-time hotspot primary key set.

In one or more embodiments of the present disclosure, the counting unit, after the current time period ends, when determining the hotspot primary key of the current time period based on the real-time hotspot primary key set, is configured to:
merge, after the current time period ends, all real-time hotspot primary key sets in the current time period, and determine the hotspot primary key in the current time period based on the merged real-time hotspot primary key set.

In one or more embodiments of the present disclosure, the counting unit, after the current time period ends, when determining the hotspot primary key of the current time period based on the real-time hotspot primary key set, is configured to:
sort the primary keys included in the real-time hotspot primary key set based on the query frequencies in the current time period, and determine the first preset number of primary keys with the highest query frequencies in the current time period as the hotspot primary keys of the current time period.

In one or more embodiments of the present disclosure, the counting unit, when sorting the primary keys included in the real-time hotspot primary key set based on the query frequencies in the current time period, is configured to:
filter out the primary keys, of which the query frequencies in the current time period are lower than the query frequency threshold for the preset single time period in the real-time hotspot primary key set, and sort the remaining primary keys in the real-time hotspot primary key set based on the query frequencies in the current time period.

In one or more embodiments of the present disclosure, the counting unit, when outputting the query frequency of the hotspot primary key of the current time period in the current time period, is configured to:
determine whether the preset queue is full, where the preset queue is used to store query frequencies of hotspot primary keys of the second preset number of past time periods in corresponding time periods;
if the preset queue is not full, store the query frequency of the hotspot primary key in the current time period in the preset queue; or
if the preset queue is full, delete the query frequency of the hotspot primary key of the earliest time period in the corresponding time period in the preset queue, and store the query frequency of the hotspot primary key of the current time period in the current time period in the preset queue.

In one or more embodiments of the present disclosure, the counting unit is further configured to:
in response to a read request for the query frequency of the hotspot primary key of any target time period in the corresponding time period in the preset queue, output the query frequency of the hotspot primary key of the target time period in the corresponding time period, and delete the query frequency of the hotspot primary key of the target time period in the corresponding time period from the preset queue.

The apparatus provided by this embodiment can be used to perform the technical solutions in the preceding method embodiments, and the implementation principles and technical effects thereof are similar, which will not be repeated in this embodiment.

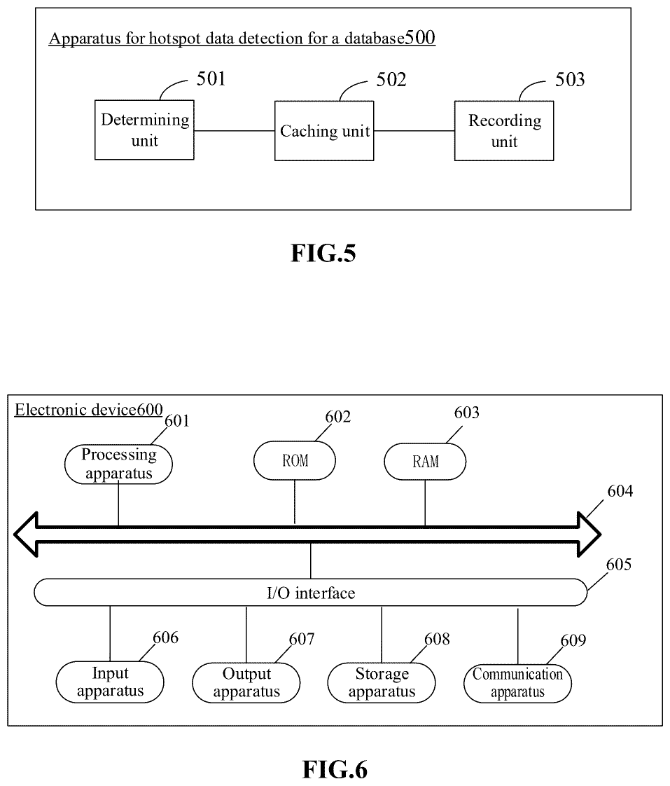

Reference is made to FIG. 6, which illustrates a schematic diagram of a structure of an electronic device 600 suitable for implementing embodiments of the present disclosure. The electronic device 600 may be a terminal device or a server. The terminal device may include, but is not limited to, mobile terminals such as a mobile phone, a notebook computer, a digital broadcast receiver, a personal digital assistant (abbreviated as PDA), a tablet computer, a portable media player (abbreviated as PMP), a vehicle-mounted terminal (such as a vehicle-mounted navigation terminal), etc., and fixed terminals such as a digital TV, a desktop computer, etc. The electronic device shown in FIG. 6 is only an example, and should not impose any restrictions on the function and scope of use of the embodiments of the present disclosure.

As shown in FIG. 6, the electronic device 600 may include a processing apparatus (such as a central processing unit, a graphics processing unit, etc.) 601, which can perform various appropriate actions and processing according to a program stored in a read-only memory (abbreviated as ROM) 602 or a program loaded from a storage apparatus 608 into a random access memory (abbreviated as RAM) 603. The RAM 603 further stores various programs and data required for the operation of the electronic device 600. The processing apparatus 601, the ROM 602, and the RAM 603 are connected to each other through a bus 604. An input/output (I/O) interface 605 is also connected to the bus 604.

Generally, the following apparatuses may be connected to the I/O interface 605: an input apparatus 606 including, for example, a touchscreen, a touchpad, a keyboard, a mouse, a camera, a microphone, an accelerometer, a gyroscope, etc.; an output apparatus 607 including, for example, a liquid crystal display (abbreviated as LCD), a speaker, a vibrator, etc.; a storage apparatus 608 including, for example, a magnetic tape, a hard disk, etc.; and a communication apparatus 609. The communication apparatus 609 can allow the electronic device 600 to perform wireless or wired communication with other devices to exchange data. Although FIG. 6 shows the electronic device 600 having various apparatuses, it should be understood that it is not required to implement or have all the apparatuses shown. Alternatively, more or fewer apparatuses may be implemented or provided.

In particular, according to the embodiments of the present disclosure, the processes described above with reference to the flowcharts may be implemented as a computer software program. For example, an embodiment of the present disclosure includes a computer program product, which includes a computer program carried on a computer-readable medium, and the computer program includes program code for executing the methods shown in the flowcharts. In such an embodiment, the computer program may be downloaded and installed from a network through the communication apparatus 609, or may be installed from the storage apparatus 608, or may be installed from the ROM 602. When the computer program is executed by the processing apparatus 601, the above functions defined in the methods of the embodiments of the present disclosure are executed.

It should be noted that the above computer-readable medium in the present disclosure may be a computer-readable signal medium or a computer-readable storage medium, or any combination thereof. The computer-readable storage medium may be, for example, but not limited to, an electrical, magnetic, optical, electromagnetic, infrared, or semiconductor system, apparatus or device, or any combination thereof. More specific examples of the computer-readable storage medium may include, but are not limited to: an electrical connection with one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. In the present disclosure, the computer-readable storage medium may be any tangible medium that contains or stores a program, and the program may be used by or in combination with an instruction execution system, apparatus or device. In the present disclosure, the computer-readable signal medium may include a data signal propagated in a baseband or as part of a carrier wave, in which computer-readable program code is carried. The data signal propagated in this manner may take many forms, including but not limited to an electromagnetic signal, an optical signal, or any suitable combination thereof. The computer-readable signal medium may also be any computer-readable medium other than the computer-readable storage medium. The computer-readable signal medium may send, propagate, or transmit a program used by or in combination with an instruction execution system, apparatus or device. The program code included on the computer-readable medium may be transmitted by any suitable medium, including but not limited to: a wire, an optical cable, RF (radio frequency), etc., or any suitable combination thereof.

The above computer-readable medium may be included in the above electronic device, or may exist alone without being assembled into the electronic device.

The above computer-readable medium carries one or more programs, and when the one or more programs are executed by the electronic device, the electronic device is caused to execute the methods shown in the above embodiments.

The computer program code for performing the operations of the present disclosure may be written in one or more programming languages or a combination thereof, where the above programming languages include object-oriented programming languages such as Java, Smalltalk, C++, and also include conventional procedural programming languages such as “C” language or similar programming languages. The program code may be executed entirely on a user's computer, partly on a user's computer, as a stand-alone software package, partly on a user's computer and partly on a remote computer, or entirely on a remote computer or server. In the case involving the remote computer, the remote computer may be connected to the user's computer through any kind of network, including a local area network (abbreviated as LAN) or a wide area network (abbreviated as WAN), or the connection may be made to an external computer (for example, through the Internet using an Internet service provider).

The flowcharts and block diagrams in the drawings illustrate the architecture, functionality, and operation of possible implementations of systems, methods and computer program products according to various embodiments of the present disclosure. In this regard, each block in the flowchart or block diagram may represent a module, a program segment, or a portion of code, which includes one or more executable instructions for implementing specified logical functions. It should also be noted that, in some alternative implementations, the functions noted in the blocks may also occur out of the order noted in the drawings. For example, two blocks shown in succession may, in fact, be executed substantially concurrently, or the blocks may sometimes be executed in the reverse order, depending upon the functionality involved. It will also be noted that each block of the block diagrams and/or flowcharts, and combinations of blocks in the block diagrams and/or flowcharts, can be implemented by special purpose hardware-based systems that perform the specified functions or acts, or combinations of special purpose hardware and computer instructions.

The units involved in the embodiments described in the present disclosure may be implemented in software or hardware. The name of a unit does not constitute a limitation on the unit itself under certain circumstances, for example, a first acquisition unit may also be described as “a unit for acquiring at least two Internet Protocol addresses”.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, a machine-readable medium may be a tangible medium that may include or store a program for use by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

In a first aspect, according to one or more embodiments of the present disclosure, a method for hotspot data detection for a database is provided, and the method includes:
receiving a database query instruction, and determining whether a target primary key of data to be queried exists in a real-time hotspot primary key set corresponding to a current time period;
if the target primary key does not exist in the real-time hotspot primary key set, controlling, through a target cache, whether to add the target primary key to the real-time hotspot primary key set, where the target cache is a cache based on a least recently used algorithm;
if the target primary key exists in the real-time hotspot primary key set, accumulating, in the real-time hotspot primary key set, a query frequency of the target primary key in the current time period; and
determining, after the current time period ends, a hotspot primary key of the current time period based on the real-time hotspot primary key set, and outputting a query frequency of the hotspot primary key of the current time period in the current time period.

According to one or more embodiments of the present disclosure, controlling, through a target cache, whether to add the target primary key to the real-time hotspot primary key set includes:
determining whether the target primary key is stored in the target cache;
if the target primary key is not stored in the target cache, adding the target primary key to the target cache based on the least recently used algorithm; or
if the target primary key is stored in the target cache, removing the target primary key from the target cache, and adding the target primary key to the real-time hotspot primary key set.

According to one or more embodiments of the present disclosure, the method further includes:
determining the number of primary keys allowed to be stored in the target cache based on the total number of queries allowed by the database in a single time period and a query frequency threshold for the preset single time period, and configuring the storage space of the target cache based on the number of primary keys allowed to be stored.

According to one or more embodiments of the present disclosure, adding the target primary key to the real-time hotspot primary key set includes:
determining whether the number of primary keys included in a first real-time hotspot primary key set corresponding to the current time period reaches a preset primary key number threshold;
if the preset primary key number threshold is not reached, adding the target primary key to the first real-time hotspot primary key set; or
if the preset primary key number threshold is reached, creating a second real-time hotspot primary key set corresponding to the current time period, and adding the target primary key to the second real-time hotspot primary key set.

According to one or more embodiments of the present disclosure, determining, after the current time period ends, the hotspot primary key of the current time period based on the real-time hotspot primary key set includes:
merging, after the current time period ends, all real-time hotspot primary key sets in the current time period, and determining the hotspot primary key of the current time period based on the merged real-time hotspot primary key set.

According to one or more embodiments of the present disclosure, determining, after the current time period ends, the hotspot primary key of the current time period based on the real-time hotspot primary key set includes:
sorting the primary keys included in the real-time hotspot primary key set based on the query frequencies in the current time period, and determining the first preset number of primary keys with the highest query frequencies in the current time period as the hotspot primary keys in the current time period.

According to one or more embodiments of the present disclosure, sorting the primary keys included in the real-time hotspot primary key set based on the query frequencies in the current time period includes:
filtering out the primary keys, of which query frequencies in the current time period are lower than the query frequency threshold for the preset single time period in the real-time hotspot primary key set, and sorting the remaining primary keys in the real-time hotspot primary key set based on the query frequencies in the current time period.

According to one or more embodiments of the present disclosure, outputting the query frequency of the hotspot primary key of the current time period in the current time period includes:
determining whether the preset queue is full, where the preset queue is used to store query frequencies of hotspot primary keys of the second preset number of past time periods in corresponding time periods;
if the preset queue is not full, storing the query frequency of the hotspot primary key in the current time period in the preset queue; or
if the preset queue is full, deleting the query frequency of the hotspot primary key of the earliest time period in the corresponding time period in the preset queue, and storing the query frequency of the hotspot primary key of the current time period in the current time period in the preset queue.

According to one or more embodiments of the present disclosure, the method further includes:
in response to a read request for the query frequency of the hotspot primary key of any target time period in the corresponding time period in the preset queue, outputting the query frequency of the hotspot primary key of the target time period in the corresponding time period, and deleting the query frequency of the hotspot primary key of the target time period in the corresponding time period from the preset queue.

In a second aspect, according to one or more embodiments of the present disclosure, an apparatus for hotspot data detection for a database is provided, and the apparatus includes:
a determining unit configured to receive a database query instruction, and determine whether a target primary key of data to be queried exists in a real-time hotspot primary key set corresponding to a current time period;
a caching unit configured to, if the target primary key does not exist in the real-time hotspot primary key set, control, through a target cache, whether to add the target primary key to the real-time hotspot primary key set, where the target cache is a cache based on a least recently used algorithm;
a recording unit configured to, if the target primary key exists in the real-time hotspot primary key set, accumulate, in the real-time hotspot primary key set, a query frequency of the target primary key in the current time period; and
a counting unit configured to determine, after the current time period ends, a hotspot primary key of the current time period based on the real-time hotspot primary key set, and output a query frequency of the hotspot primary key of the current time period in the current time period.

According to one or more embodiments of the present disclosure, the caching unit, when controlling, through the target cache, whether to add the target primary key to the real-time hotspot primary key set, is configured to:
determine whether the target primary key is stored in the target cache; and
if the target primary key is not stored in the target cache, add the target primary key to the target cache based on the least recently used algorithm; or
if the target primary key is stored in the target cache, remove the target primary key from the target cache, and add the target primary key to the real-time hotspot primary key set.

According to one or more embodiments of the present disclosure, the caching unit is further configured to:
determine the number of primary keys allowed to be stored in the target cache based on the total number of queries allowed by the database in a single time period and a query frequency threshold for a preset single time period, and configure the storage space of the target cache based on the number of primary keys allowed to be stored.

According to one or more embodiments of the present disclosure, the recording unit, when adding the target primary key to the real-time hotspot primary key set, is configured to:
determine whether the number of primary keys included in a first real-time hotspot primary key set corresponding to the current time period reaches a preset primary key number threshold;
if the preset primary key number threshold is not reached, add the target primary key to the first real-time hotspot primary key set; or
if the preset primary key number threshold is reached, create a second real-time hotspot primary key set corresponding to the current time period, and add the target primary key to the second real-time hotspot primary key set.

According to one or more embodiments of the present disclosure, the counting unit, when determining, after the current time period ends, the hotspot primary key of the current time period based on the real-time hotspot primary key set, is configured to:
merge, after the current time period ends, all real-time hotspot primary key sets in the current time period, and determine the hotspot primary key of the current time period based on the merged real-time hotspot primary key set.

According to one or more embodiments of the present disclosure, the counting unit, when determining, after the current time period ends, the hotspot primary key of the current time period based on the real-time hotspot primary key set, is configured to:
sort the primary keys included in the real-time hotspot primary key set based on the query frequencies in the current time period, and determine the first preset number of primary keys with the highest query frequencies in the current time period as the hotspot primary keys of the current time period.

According to one or more embodiments of the present disclosure, the counting unit, when sorting the primary keys included in the real-time hotspot primary key set based on the query frequencies in the current time period, is configured to:
filter out the primary keys of which the query frequencies in the current time period are lower than the query frequency threshold for the preset single time period in the real-time hotspot primary key set, and sort the remaining primary keys in the real-time hotspot primary key set based on the query frequencies in the current time period.

According to one or more embodiments of the present disclosure, the counting unit, when outputting the query frequency of the hotspot primary key of the current time period in the current time period, is configured to:
determine whether the preset queue is full, where the preset queue is used to store query frequencies of hotspot primary keys of the second preset number of past time periods in corresponding time periods;
if the preset queue is not full, store the query frequency of the hotspot primary key of the current time period in the current time period in the preset queue; or
if the preset queue is full, delete the query frequency of the hotspot primary key of the earliest time period in the corresponding time period in the preset queue, and store the query frequency of the hotspot primary key of the current time period in the current time period in the preset queue.

According to one or more embodiments of the present disclosure, the counting unit is further configured to:
in response to a read request for the query frequency of the hotspot primary key of any target time period in the corresponding time period in the preset queue, output the query frequency of the hotspot primary key of the target time period in the corresponding time period, and delete the query frequency of the hotspot primary key of the target time period in the corresponding time period from the preset queue.
In a third aspect, according to one or more embodiments of the present disclosure, an electronic device is provided, and the electronic device includes: at least one processor and a memory.

The memory stores computer-executable instructions.

The at least one processor executes the computer-executable instructions stored in the memory, to cause the at least one processor to perform the method for hotspot data detection for a database according to the preceding first aspect and various possible designs thereof.

In a fourth aspect, according to one or more embodiments of the present disclosure, a computer-readable storage medium is provided. The computer-readable storage medium stores computer-executable instructions which, when executed by a processor, implement the method for hotspot data detection for a database according to the preceding first aspect and various possible designs thereof.

In a fifth aspect, according to one or more embodiments of the present disclosure, a computer program product is provided. The computer program product includes computer-executable instructions which, when executed by a processor, implement the method for hotspot data detection for a database according to the preceding first aspect and various possible designs thereof.

The above descriptions are merely preferred embodiments of the present disclosure and explanations of the applied technical principles. Those skilled in the art should understand that the scope of disclosure involved in the present disclosure is not limited to the technical solutions formed by the specific combination of the above technical features, and should also cover other technical solutions formed by any combination of the above technical features or equivalent features thereof without departing from the above disclosed concept, for example, a technical solution formed by replacing the above features with technical features with similar functionality disclosed in the present disclosure (but not limited to).

In addition, although operations are depicted in a particular order, it should not be understood as requiring these operations to be performed in the specific order shown or in a sequential order. Under certain circumstances, multitasking and parallel processing may be advantageous. Similarly, although several specific implementation details are included in the above discussion, these should not be construed as limiting the scope of the present disclosure. Certain features that are described in the context of separate embodiments may also be implemented in combination in a single embodiment. Conversely, various features described in the context of a single embodiment may also be implemented in multiple embodiments individually or in any suitable sub-combination.

Although the subject matter has been described in language specific to structural features and/or logical actions of the methods, it should be understood that the subject matter defined in the appended claims is not necessarily limited to the specific features or actions described above. Rather, the specific features and actions described above are merely example forms for implementing the claims.

I/We claim:

1. A method for hotspot data detection for a database, comprising:
receiving a database query instruction, and determining whether a target primary key of data to be queried exists in a real-time hotspot primary key set corresponding to a current time period;
in response to the target primary not existing in the real-time hotspot primary key set, controlling, through a target cache, whether to add the target primary key to the real-time hotspot primary key set, wherein the target cache is a cache based on a least recently used algorithm;
in response to the target primary key existing in the real-time hotspot primary key set, accumulating, in the real-time hotspot primary key set, a query frequency of the target primary key in the current time period; and
determining, after the current time period ends, a hotspot primary key of the current time period based on the real-time hotspot primary key set, and outputting a query frequency of the hotspot primary key of the current time period in the current time period.

2. The method according to claim 1, wherein controlling, through the target cache, whether to add the target primary key to the real-time hotspot primary key set comprises:
determining whether the target primary key is stored in the target cache;
in response to the target primary key being not stored in the target cache, adding the target primary key to the target cache based on a least recently used algorithm; or
in response to the target primary key being stored in the target cache, removing the target primary key from the target cache, and adding the target primary key to the real-time hotspot primary key set.

3. The method according to claim 1, wherein the method further comprises:
determining a number of primary keys allowed to be stored in the target cache based on a total number of queries allowed by the database in a single time period and a query frequency threshold for a preset single time period, and configuring a storage space of the target cache based on the number of primary keys allowed to be stored.

4. The method according to claim 1, wherein adding the target primary key to the real-time hotspot primary key set comprises:
determining whether a number of primary keys comprised in a first real-time hotspot primary key set corresponding to the current time period reaches a preset primary key number threshold;
in response to the preset primary key number threshold being not reached, adding the target primary key to the first real-time hotspot primary key set; or
in response to the preset primary key number threshold being reached, creating a second real-time hotspot primary key set corresponding to the current time period, and adding the target primary key to the second real-time hotspot primary key set.

5. The method according to claim 4, wherein determining, after the current time period ends, the hotspot primary key of the current time period based on the real-time hotspot primary key set comprises:
merging, after the current time period ends, all real-time hotspot primary key sets in the current time period, and determining the hotspot primary key of the current time period based on the merged real-time hotspot primary key set.

6. The method according to claim 1, wherein determining, after the current time period ends, the hotspot primary key of the current time period based on the real-time hotspot primary key set comprises:
sorting primary keys comprised in the real-time hotspot primary key set based on query frequencies in the current time period, and determining a first preset number of the primary keys with the highest query frequencies in the current time period as the hotspot primary keys of the current time period.

7. The method according to claim 6, wherein sorting the primary keys comprised in the real-time hotspot primary key set based on the query frequencies in the current time period comprises:
filtering out the primary keys, of which the query frequencies in the current time period are lower than a query frequency threshold for a preset single time period, in the real-time hotspot primary key set, and sorting the remaining primary keys in the real-time hotspot primary key set based on the query frequencies in the current time period.

8. The method according to claim 1, wherein outputting the query frequency of the hotspot primary key of the current time period in the current time period comprises:
determining whether a preset queue is full, wherein the preset queue is used for storing query frequencies of hotspot primary keys of a second preset number of past time periods in corresponding time periods;
in response to the preset queue being not full, storing the query frequency of the hotspot primary key of the current time period in the current time period in the preset queue; or
in response to the preset queue being full, deleting the query frequency of the hotspot primary key of the earliest time period in the corresponding time period in the preset queue, and storing the query frequency of the hotspot primary key of the current time period in the current time period in the preset queue.

9. The method according to claim 8, wherein the method further comprises:
in response to a read request for the query frequency of the hotspot primary key of any target time period in the corresponding time period in the preset queue, outputting the query frequency of the hotspot primary key of the target time period in the corresponding time period, and deleting the query frequency of the hotspot primary key of the target time period in the corresponding time period from the preset queue.

10. An electronic device, comprising:
at least one processor and a memory;
wherein the memory stores computer-executable instructions; and
the at least one processor executes the computer-executable instructions stored in the memory, to configure the at least one processor to:
receive a database query instruction, and determine whether a target primary key of data to be queried exists in a real-time hotspot primary key set corresponding to a current time period;
in response to the target primary not existing in the real-time hotspot primary key set, control, through a target cache, whether to add the target primary key to the real-time hotspot primary key set, wherein the target cache is a cache based on a least recently used algorithm;
in response to the target primary key existing in the real-time hotspot primary key set, accumulate, in the real-time hotspot primary key set, a query frequency of the target primary key in the current time period; and
determine, after the current time period ends, a hotspot primary key of the current time period based on the real-time hotspot primary key set, and output a query frequency of the hotspot primary key of the current time period in the current time period.

11. The electronic device according to claim 10, wherein the computer-executable instructions to configure the at least one processor to control, through the target cache, whether to add the target primary key to the real-time hotspot primary key set comprise computer-executable instructions to configure the at least one processor to:
determine whether the target primary key is stored in the target cache;
in response to the target primary key being not stored in the target cache, add the target primary key to the target cache based on a least recently used algorithm; or
in response to the target primary key being stored in the target cache, remove the target primary key from the target cache, and add the target primary key to the real-time hotspot primary key set.

12. The electronic device according to claim 10, wherein the computer-executable instructions further configure the at least one processor to:
determine a number of primary keys allowed to be stored in the target cache based on a total number of queries allowed by the database in a single time period and a query frequency threshold for a preset single time period, and configure a storage space of the target cache based on the number of primary keys allowed to be stored.

13. The electronic device according to claim 10, wherein the computer-executable instructions to configure the at least one processor to add the target primary key to the real-time hotspot primary key set comprise computer-executable instructions to configure the at least one processor to:
determine whether a number of primary keys comprised in a first real-time hotspot primary key set corresponding to the current time period reaches a preset primary key number threshold;
in response to the preset primary key number threshold being not reached, add the target primary key to the first real-time hotspot primary key set; or
in response to the preset primary key number threshold being reached, create a second real-time hotspot primary key set corresponding to the current time period, and add the target primary key to the second real-time hotspot primary key set.

14. The electronic device according to claim 13, wherein the computer-executable instructions to configure the at least one processor to determine, after the current time period ends, the hotspot primary key of the current time period based on the real-time hotspot primary key set comprise computer-executable instructions to configure the at least one processor to:
merge, after the current time period ends, all real-time hotspot primary key sets in the current time period, and determine the hotspot primary key of the current time period based on the merged real-time hotspot primary key set.

15. The electronic device according to claim 10, wherein the computer-executable instructions to configure the at least one processor to determine, after the current time period ends, the hotspot primary key of the current time period based on the real-time hotspot primary key set comprise computer-executable instructions to configure the at least one processor to:
sort primary keys comprised in the real-time hotspot primary key set based on query frequencies in the current time period, and determine a first preset number of the primary keys with the highest query frequencies in the current time period as the hotspot primary keys of the current time period.

16. The electronic device according to claim 15, wherein the computer-executable instructions to configure the at least one processor to sort the primary keys comprised in the real-time hotspot primary key set based on the query frequencies in the current time period comprise computer-executable instructions to configure the at least one processor to:
filter out the primary keys, of which the query frequencies in the current time period are lower than a query frequency threshold for a preset single time period, in the real-time hotspot primary key set, and sort the remaining primary keys in the real-time hotspot primary key set based on the query frequencies in the current time period.

17. The electronic device according to claim 10, wherein the computer-executable instructions to configure the at least one processor to output the query frequency of the hotspot primary key of the current time period in the current time period comprise computer-executable instructions to configure the at least one processor to:
determine whether a preset queue is full, wherein the preset queue is used for storing query frequencies of hotspot primary keys of a second preset number of past time periods in corresponding time periods;
in response to the preset queue being not full, store the query frequency of the hotspot primary key of the current time period in the current time period in the preset queue; or
in response to the preset queue being full, delete the query frequency of the hotspot primary key of the earliest time period in the corresponding time period in the preset queue, and store the query frequency of the hotspot primary key of the current time period in the current time period in the preset queue.

18. The electronic device according to claim 17, wherein the computer-executable instructions further configure the at least one processor to:
in response to a read request for the query frequency of the hotspot primary key of any target time period in the corresponding time period in the preset queue, output the query frequency of the hotspot primary key of the target time period in the corresponding time period, and delete the query frequency of the hotspot primary key of the target time period in the corresponding time period from the preset queue.

19. A non-transitory computer-readable storage medium, storing computer-executable instructions which, when executed by a processor, configure the processor to:
receive a database query instruction, and determine whether a target primary key of data to be queried exists in a real-time hotspot primary key set corresponding to a current time period;
in response to the target primary not existing in the real-time hotspot primary key set, control, through a target cache, whether to add the target primary key to the real-time hotspot primary key set, wherein the target cache is a cache based on a least recently used algorithm;
in response to the target primary key existing in the real-time hotspot primary key set, accumulate, in the real-time hotspot primary key set, a query frequency of the target primary key in the current time period; and
determine, after the current time period ends, a hotspot primary key of the current time period based on the real-time hotspot primary key set, and output a query frequency of the hotspot primary key of the current time period in the current time period.

20. The non-transitory computer-readable storage medium according to claim 19, the computer-executable instructions to configure the processor to control, through the target cache, whether to add the target primary key to the real-time hotspot primary key set comprise computer-executable instructions to configure the processor to:
determine whether the target primary key is stored in the target cache;
in response to the target primary key being not stored in the target cache, add the target primary key to the target cache based on a least recently used algorithm; or
in response to the target primary key being stored in the target cache, remove the target primary key from the target cache, and add the target primary key to the real-time hotspot primary key set.
